(19) United States
(12) Patent Application Publication
(10) Pub. No.: US 2024/0244506 A1
(43) Pub. Date: Jul. 18, 2024

(54) METHOD AND APPARATUS FOR MANAGING INTER-RAT CAPABILITY OF USER EQUIPMENT UNDER DISASTER SITUATION

(71) Applicant: MEDIATEK INC., Hsin-Chu (TW)

(72) Inventors: Shuang-An Chou, Hsinchu City (TW); Cheng-Hsiao KO, Hsinchu City (TW); Yu-Hsiu Tseng, Hsinchu City (TW); Kuang-Ting Cheng, Hsinchu City (TW)

(73) Assignee: MEDIATEK INC., Hsin-Chu (TW)

(21) Appl. No.: 18/503,199

(22) Filed: Nov. 7, 2023

Related U.S. Application Data
(60) Provisional application No. 63/439,548, filed on Jan. 17, 2023.

(51) Int. Cl. H04W 48/02; H04W 48/16; H04W 60/04

(52) U.S. Cl. CPC H04W 48/02; H04W 48/16; H04W 60/04; H04W 84/042

(57) ABSTRACT

A method for managing inter-radio access technology (inter-RAT) capability of a user equipment (UE) includes: receiving system information broadcasted from a public land mobile network (PLMN), wherein the system information is indicative of a disaster condition of the PLMN, and the UE is currently camps on a first RAT of the PLMN; and in response to receiving the system information, performing a PLMN search operation to camp on a second RAT of the PLMN, and performing an inter-RAT management operation to prevent the UE from transiting to the first RAT of the PLMN.

### CROSS REFERENCE TO RELATED APPLICATIONS

This application claims the benefit of U.S. Provisional Application No. 63/439,548, filed on Jan. 17, 2023. The content of the application is incorporated herein by reference.

### BACKGROUND

The present invention relates to wireless communications, and more particularly, to a method and apparatus for managing inter-radio access technology (inter-RAT) capability of a user equipment (UE) under a disaster situation.

A core network operator provides telecommunication services (e.g., voice and data services) to a UE through a communication network. One example of the communication network is a public land mobile network (PLMN) that includes a core network and one or more base stations (which collectively form an access network connected to the core network). A PLMN has a geographical coverage area in which the base station(s) provide voice and data services to mobile subscribers. Subscribers are identified and authenticated on the UE using a subscriber identification module (SIM)/universal subscriber identification module (USIM) card. When the UE is switched on or recovers from a lack of coverage, the UE needs to perform a PLMN selection process. Ina PLMN selection process, the UE selects a PLMN, searches for a suitable cell of the selected PLMN, chooses that cell to provide available services to the UE, and monitors its control channel (aka “camps on the cell”). The UE then registers its presence in the tracking area of the chosen cell of the selected PLMN by performing a location update procedure.

The network may have a situation that makes infrastructure shut down, e.g., fire, earthquake, or power shut-down. Minimization of service interruption (MINT) concept is to find a PLMN which can be used for disaster roaming when disaster happens. For example, the 5G system (5GS) provides a disaster roaming service (e.g., voice and data service) for a UE from a PLMN with disaster condition, where the disaster roaming information is broadcasted in a system information block (SIB) of a SIB type 15 (i.e., SIB15). Typically, when a cell of the PLMN broadcasts SIB15 that indicates the disaster condition, the UE performs a PLMN search operation to find a target PLMN to camp on. The UE still needs to search allowable PLMNs before camping on a cell that accepts disaster roaming from the PLMN with disaster condition. Hence, it is possible that the target PLMN selected by the PLMN search operation is the original PLMN (i.e., PLMN with disaster condition), but the UE camps on a different RAT of the original PLMN. Since the original RAT of the original PLMN has been broken due to disaster, it is unable to be reselected via inter-RAT mechanism. If the UE transits from other RAT to original RAT, service might be lost for a while. It is also possible that the target PLMN selected by the PLMN search operation is other PLMN that accepts disaster roaming from the original PLMN (i.e., PLMN with disaster condition), where the UE camps on the same RAT on the other PLMN. In most cases, other RAT on the other PLMN does not support disaster roaming. If inter-RAT is performed to make the UE transit to the other RAT, service might be interrupted for a while.

Thus, there is a need for an innovative design which is capable of smartly managing inter-RAT capability of the UE to prevent the UE from suffering service interruption under a situation that a PLMN broadcasts system information that is indicative of a disaster condition.

### SUMMARY

One of the objectives of the claimed invention is to provide a method and apparatus for managing inter-RAT capability of a UE under a disaster situation.

According to a first aspect of the present invention, an exemplary method for managing inter-radio access technology (inter-RAT) capability of a user equipment (UE) is disclosed. The exemplary method includes: receiving system information broadcasted from a public land mobile network (PLMN), wherein the system information is indicative of a disaster condition of the PLMN, and the UE is currently camps on a first RAT of the PLMN; and in response to receiving the system information, performing a PLMN search operation to camp on a second RAT of the PLMN, and performing an inter-RAT management operation to prevent the UE from transiting to the first RAT of the PLMN.

According to a second aspect of the present invention, an exemplary user equipment (UE) is disclosed. The exemplary UE includes a wireless communication circuit and a control circuit. The wireless communication circuit is arranged to communicate with a public land mobile network (PLMN) on which the UE camps. The control circuit is arranged to receive system information broadcasted from the PLMN, wherein the system information is indicative of a disaster condition of the PLMN, and the UE is currently camps on a first RAT of the PLMN. In response to receiving the system information, the control circuit si further arranged to perform a PLMN search operation to camp on a second RAT of the PLMN, and perform an inter-RAT management operation to prevent the UE from transiting to the first RAT of the PLMN.

According to a third aspect of the present invention, an exemplary method for managing inter-radio access technology (inter-RAT) capability of a user equipment (UE) is disclosed. The exemplary method includes: receiving system information broadcasted from a first public land mobile network (PLMN), wherein the system information is indicative of a disaster condition of the first PLMN, and the UE is currently camps on a first RAT of the first PLMN; and in response to receiving the system information, performing a PLMN search operation to camp on the first RAT of a second PLMN, and performing an inter-RAT management operation to prevent the UE from transiting to a second RAT of the second PLMN. The first RAT is a New Radio (NR) system, and the inter-RAT management operation is performed at an access-stratum (AS) level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to an embodiment of the present invention.

FIG. 2 is flowchart illustrating a first inter-RAT management scheme according to an embodiment of the present invention.

FIG. 3 is a diagram illustrating a case where a UE camps on original PLMN but different RAT when disaster happens.

FIG. 4 is flowchart illustrating a second inter-RAT management scheme according to an embodiment of the present invention.

FIG. 5 is a diagram illustrating a case where a UE camps on other PLMN when disaster happens.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

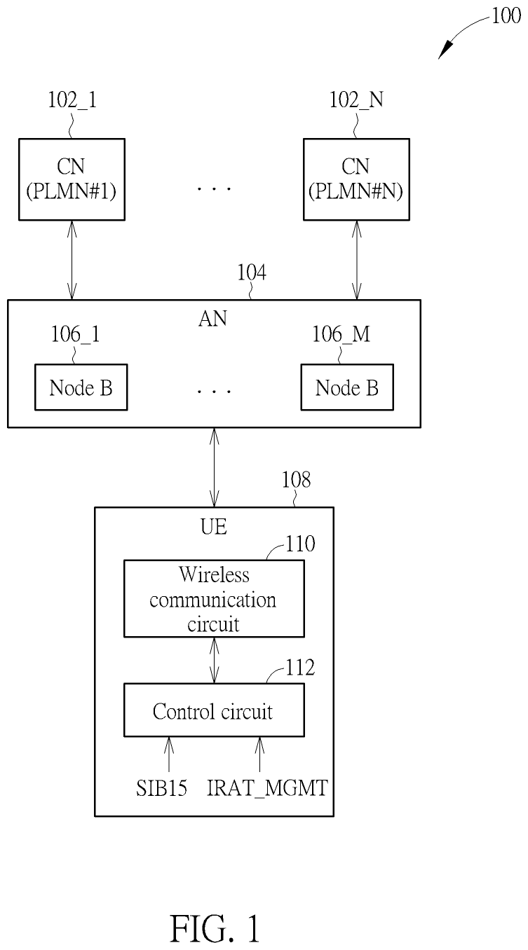

FIG. 1 is a diagram illustrating a wireless communication system according to an embodiment of the present invention. The wireless communication system 100 includes a plurality of core networks (CNs) 102_1-102 N (N≥2), an access network (AN) 104 including a plurality of base stations (labeled by “Node B”) 106_1-106_M (M≥2) , and a user equipment (UE) 108. In this embodiment, CNs 102_1-102_N are owned and operated by different operators, such that different PLMNs, including PLMN#1-PLMN#N, co-exist in the wireless communication system 100. The UE 108 may be a smartphone, and may perform a PLMN selection process to camp on a cell of a selected PLMN, where the cell is served by one of the base stations 106_1-106_M that is connected to a CN of the selected PLMN. It should be noted that a same cell may belong to different PLMNs, and different cells in the same PLMN may have different disaster roaming allowance configurations.

Each of the PLMNs, including PLMN#1-PLMN#N, may be a multi-RAT system that supports different RATS. For example, different RATS may include a 5G New Radio (NR) system and a 4G Long Term Evolution (LTE) system. However, this is for illustrative purposes only, and is not meant to be a limitation of the present invention. For brevity and simplicity, the following assumes that different RATS of the same PLMN are 5G NR and 4G LTE. In practice, the same inter-RAT management concept proposed by the present invention can be applied to RATS other than 5G NR and 4G LTE. These alternative designs all fall within the scope of the present invention.

After the UE 108 camps on a selected PLMN, it may transit from a current RAT of the serving PLMN to a different RAT of the serving PLMN via inter-RAT mechanism. In this embodiment, the UE 108 supports the proposed inter-RAT management scheme used to prevent the UE 108 from transiting to original RAT of original PLMN (which is a PLMN with disaster condition) or other RAT of other PLMN (which is a PLMN that accepts disaster roaming from a PLMN with disaster condition). As shown in FIG. 1, the UE 108 includes a wireless communication circuit 110 and a control circuit 112. It should be noted that only the components pertinent to the present invention are illustrated in FIG. 1. In practice, the UE 108 is allowed to include additional components to achieve other designated functions. The wireless communication circuit 110 includes hardware components required to deal with a transmit (TX) function and a receive (RX) function, and is arranged to communicate with a selected PLMN (e.g., one of PLMN#1-PLMN#N) on which the UE 108 currently camps. The control circuit 112 is responsible for managing the overall operation of the UE 108. For example, the control circuit 112 may perform the proposed inter-RAT management scheme by using dedicated hardware. For another example, the control circuit 112 may perform the proposed inter-RAT management scheme by using software running on a processor.

In a case where the UE 108 camps on the original PLMN but different RAT (e.g., LTE) after being informed that disaster may be happening on the original PLMN, the UE 108 can perform an inter-RAT management operation IRAT MGMT to prevent the UE 108 from transiting to the original RAT (e.g., NR). For example, the control circuit 112 is arranged to receive system information SIB15 broadcasted from the serving PLMN, wherein the system information SIB15 is indicative of a disaster condition of the serving PLMN, and the UE 108 is currently camps on a first RAT (e.g., NR) of the serving PLMN; and in response to receiving the system information SIB15, perform a PLMN search operation to camp on a second RAT (e.g., LTE) of the same serving PLMN, and perform the inter-RAT management operation IRAT_MGMT to prevent the UE 108 from transiting to the first RAT (e.g., NR) of the same serving PLMN. Since the first RAT (e.g., NR) of the same serving PLMN has been broken due to disaster, the inter-RAT management operation IRAT_MGMT prevents the UE 108 from transiting to the first RAT (e.g., NR) of the same serving PLMN, thereby keeping the UE 108 in good service without interruption. Further details of the proposed inter-RAT management operation IRAT MGMT are provided as below with reference to the accompanying drawings.

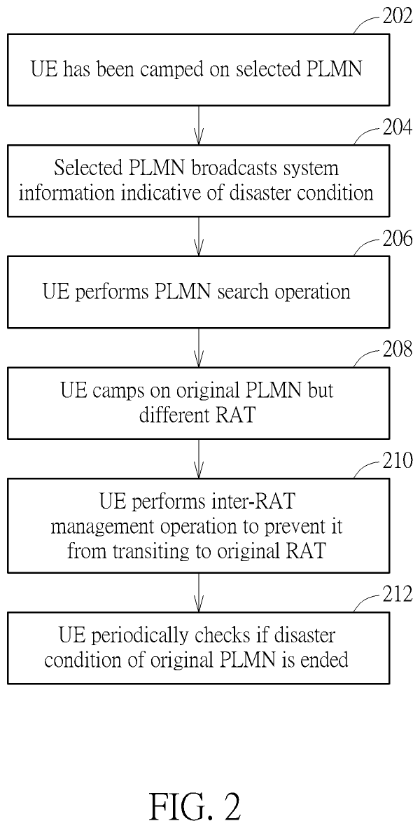

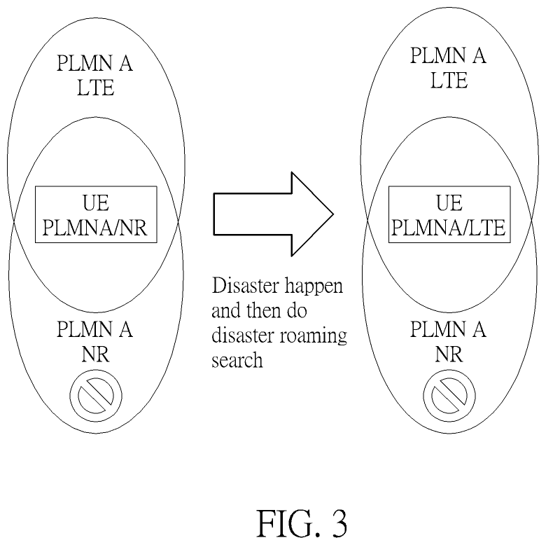

Please refer to FIG. 2 in conjunction with FIG. 1. FIG. 2 is flowchart illustrating a first inter-RAT management scheme according to an embodiment of the present invention. At step 202, the UE 108 has been camped on a selected PLMN (e.g., one of PLMN*1-PLMN*N). Hence, the selected PLMN is an original PLMN that is currently serving the UE 108. In the following, the terms “selected PLMN”, “current PLMN”, and “original PLMN” may be interchangeable. At step 204, the UE 108 receives system information SIB15 from the current PLMN, where the system information SIB15 is indicative of a disaster condition of the current PLMN. Specifically, the current PLMN broadcasts the system information SIB15 to indicate that disaster may be happening. At step 206, the UE 108 follows steps defined in the specification for performing a PLMN search operation to find a target PLMN to camp on. For example, the UE 108 still needs to search allowable PLMNs before camping on a cell that accepts disaster roaming from the current PLMN with disaster condition. Hence, it is possible that the original PLMN is selected by the PLMN search operation. At step 208, the UE 208 camps on the original PLMN but different RAT (e.g., an LTE cell of original PLMN). FIG. 3 is a diagram illustrating a case where a UE camps on original PLMN but different RAT when disaster happens. In this embodiment, the original PLMN is denoted by “PLMN A”, the original RAT is denoted by “NR”, and the different RAT is denoted by “LTE”. Since the original RAT on the original PLMN has been broken due to disaster, the UE may camp on the different RAT on the original PLMN according to the search steps defined in the specification.

At step 210, the UE 108 performs the inter-RAT management operation IRAT_MGMT to prevent the UE 108 from transiting to original RAT of the original PLMN (e.g., an NR cell of original PLMN) that has been broken due to disaster. The inter-RAT management operation IRAT_MGMT may include step(s) performed at a non-access-stratum (NAS) level only, or may include step(s) performed at an access-stratum (AS) level only, or may include step(s) performed at the NAS level and step(s) performed at the AS level.

In a first exemplary design, the inter-RAT management operation IRAT MGMT may include a NAS-level step used for disabling NR capability in an Attach request that is sent to the camped PLMN (i.e., an original PLMN with disaster condition), and/or a NAS-level step used for disabling NR capability in a tracking area update (TAU) request that is sent to the camped PLMN (i.e., an original PLMN with disaster condition), where the Attach/TAU request is set to indicate that N1 mode is not supported in UE network capability information element (IE) , and the Attach/TAU request does not carry the UE network capability IE.

In a second exemplary design, the inter-RAT management operation IRAT MGMT may include an AS-level step used for disabling support of inter-RAT related capability in LTE Capability that is sent to the camped PLMN (i.e., an original PLMN with disaster condition) to prevent handover to NR by the network. For example, the capability information irat-Parameters-NR-v1540, including sa-NR-r15, eutra-5GC-HO-ToNR-FDD-FR1-r15, etc., is not carried in LTE Capability sent to the camped PLMN.

In a third exemplary design, the inter-RAT management operation IRAT_MGMT may include an AS-level step used for setting Evolved Universal Terrestrial Radio Access Network (E-UTRAN) New Radio-Dual Connectivity (ENDC) capability of the UE 108 as off. For example, the UE 108 may try ENDC settings from the camped PLMN (i.e., an original PLMN with disaster condition) to determine whether ENDC between UE 108 and camped PLMN is already workable. If it is determined that ENDC between UE 108 and serving PLMN is not workable yet, the UE 108 may inform the camped PLMN of its ENDC capability set as off.

In a fourth exemplary design, the inter-RAT management operation IRAT_MGMT may include that the UE 108 itself decides not to perform an AS-level inter-RAT measurement, or the UE 108 itself decides not to report a result of an AS-level inter-RAT measurement to the camped PLMN (i.e., an original PLMN with disaster condition).

As mentioned above, the inter-RAT management operation IRAT_MGMT prevents the UE 108 from transiting to the original RAT (e.g. NR) that has been broken due to disaster. The original RAT can operate normally after the disaster condition of the PLMN no longer persists. At step 212, the UE 108 periodically checks if the disaster condition of the serving PLMN has ended. For example, the UE 108 may set a periodic timer, and may check the NR SIB15 status each time the periodic timer expires. After it is determined that the disaster condition of the camped PLMN has ended, the UE 108 is allowed to transit to the original RAT of the camped PLMN via inter-RAT mechanism.

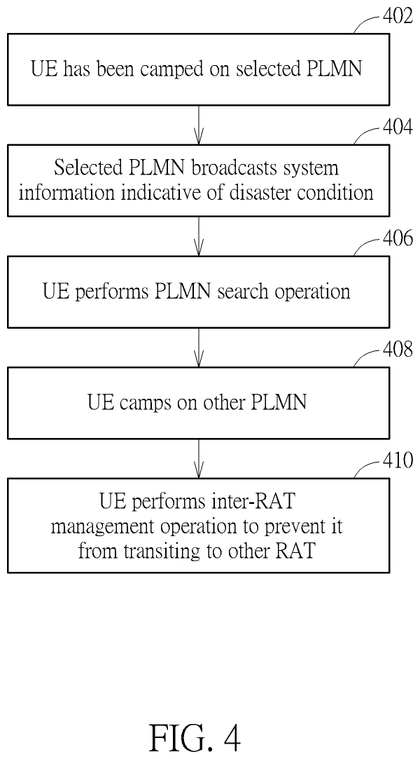

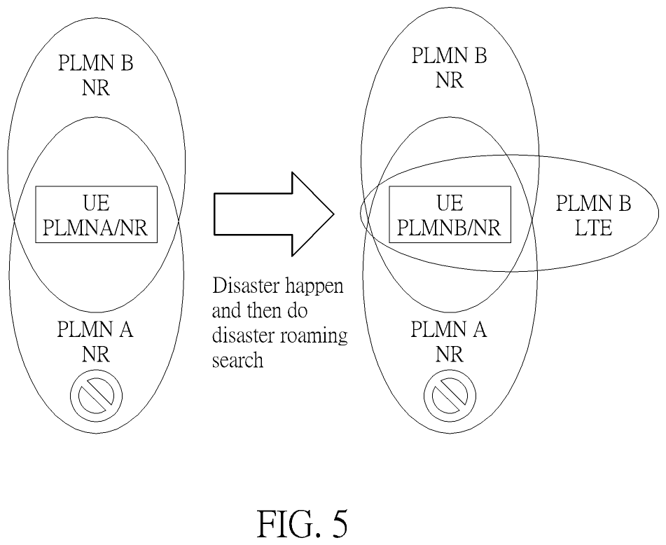

Please refer to FIG. 4 in conjunction with FIG. 1. FIG. 4 is flowchart illustrating a second inter-RAT management scheme according to an embodiment of the present invention. At step 402, the UE 108 has been camped on a selected PLMN (e.g., one of PLMN#1-PLMN#N). Hence, the selected PLMN is an original PLMN that is currently serving the UE 108. In the following, the terms “selected PLMN”, “current PLMN”, and “original PLMN” may be interchangeable. At step 404, the UE 108 receives system information SIB15 from the current PLMN, where the system information SIB15 is indicative of a disaster condition of the current PLMN. Specifically, the current PLMN broadcasts the system information SIB15 to indicate that disaster may be happening. At step 406, the UE 108 follows steps defined in the specification for performing a PLMN search operation to find a target PLMN to camp on. At step 208, the UE 208 camps on the same RAT on other PLMN (e.g., an NR cell of a PLMN that accepts disaster roaming from the original PLMN with disaster condition). FIG. 5 is a diagram illustrating a case where a UE camps on other PLMN when disaster happens. In this embodiment, the original PLMN is denoted by “PLMN A”, the original RAT is denoted by “NR”, other PLMN is denoted by “PLMN B”, and the different RAT is denoted by “LTE”. Since the original RAT on the original PLMN has been broken due to disaster, the UE may perform disaster roaming to camp on the same RAT on other PLMN according to the search steps defined in the specification.

At step 410, the UE 108 performs the inter-RAT management operation IRAT_MGMT to prevent the UE 108 from transiting from the current RAT of the other PLMN (e.g., an NR cell of a PLMN that accepts disaster roaming from the original PLMN with disaster condition) to other RAT of the other PLMN (e.g., an LTE cell of the PLMN that accepts disaster roaming from the original PLMN with disaster condition) that does not support disaster roaming. The inter-RAT management operation IRAT MGMT may include one or more steps performed at an AS level. In a first exemplary design, the inter-RAT management operation IRAT MGMT may include that the UE 108 itself decides not to perform reselection of the other RAT of the other PLMN. In a second exemplary design, the inter-RAT management operation IRAT_MGMT may include an AS-level step used for disabling support of inter-RAT related capability in NR Capability that is sent to the other PLMN on which the UE 108 is camped on for disaster roaming. For example, the capability information, including NR-InterRAT-Parameters and eutra-CGI-Reporting, is not carried in NR Capability sent to the camped PLMN that accepts disaster roaming from the original PLMN with disaster condition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing inter-radio access technology (inter-RAT) capability of a user equipment (UE), comprising:
receiving system information broadcasted from a public land mobile network (PLMN), wherein the system information is indicative of a disaster condition of the PLMN, and the UE is currently camps on a first RAT of the PLMN; and
in response to receiving the system information, performing a PLMN search operation to camp on a second RAT of the PLMN, and performing an inter-RAT management operation to prevent the UE from transiting to the first RAT of the PLMN.

2. The method of claim 1, wherein the first RAT is a New Radio (NR) system.

3. The method of claim 2, wherein the inter-RAT management operation is performed at a non-access-stratum (NAS) level.

4. The method of claim 3, wherein the inter-RAT management operation comprises:
disabling NR capability in an Attach request that is sent to the PLMN.

5. The method of claim 3, wherein the inter-RAT management operation comprises:
disabling NR capability in a tracking area update (TAU) request that is sent to the PLMN.

6. The method of claim 2, wherein the inter-RAT management operation is performed at an access-stratum (AS) level.

7. The method of claim 6, wherein the second RAT is a Long Term Evolution (LTE) system.

8. The method of claim 7, wherein the inter-RAT management operation comprises:
disabling support of inter-RAT related capability in LTE Capability that is sent to the PLMN.

9. The method of claim 7, wherein the inter-RAT management operation comprises:
setting Evolved Universal Terrestrial Radio Access Network (E-UTRAN) New Radio-Dual Connectivity (ENDC) capability of the UE as off.

10. The method of claim 7, wherein the inter-RAT management operation comprises:
not performing an inter-RAT measurement by the UE; or not reporting a result of an inter-RAT measurement by the UE.

11. The method of claim 1, further comprising:
in response to receiving the system information, periodically checking if the disaster condition of the PLMN has ended.

12. A user equipment (UE) comprising:
a wireless communication circuit, arranged to communicate with a public land mobile network (PLMN) on which the UE camps; and
a control circuit, arranged to receive system information broadcasted from the PLMN, wherein the system information is indicative of a disaster condition of the PLMN, and the UE is currently camps on a first RAT of the PLMN; and in response to receiving the system information, perform a PLMN search operation to camp on a second RAT of the PLMN, and perform an inter-RAT management operation to prevent the UE from transiting to the first RAT of the PLMN.

13. The UE of claim 12, wherein the first RAT is a New Radio (NR) system.

14. The UE of claim 13, wherein the inter-RAT management operation is performed at a non-access-stratum (NAS) level.

15. The UE of claim 13, wherein the inter-RAT management operation is performed at an access-stratum (AS) level.

16. The UE of claim 15, wherein the second RAT is a Long Term Evolution (LTE) system.

17. The UE of claim 12, wherein in response to receiving the system information, the control circuit is further arranged to periodically check if the disaster condition of the PLMN has ended.

18. A method for managing inter-radio access technology (inter-RAT) capability of a user equipment (UE), comprising:
receiving system information broadcasted from a first public land mobile network (PLMN), wherein the system information is indicative of a disaster condition of the first PLMN, and the UE is currently camps on a first RAT of the first PLMN; and
in response to receiving the system information, performing a PLMN search operation to camp on the first RAT of a second PLMN, and performing an inter-RAT management operation to prevent the UE from transiting to a second RAT of the second PLMN;
wherein the first RAT is a New . Radio (NR) system, and the inter-RAT management operation is performed at an access-stratum (AS) level.

19. The method of claim 18, wherein the inter-RAT management operation comprises:
not performing reselection of the second RAT in the second PLMN by the UE.

20. The method of claim 18, wherein the inter-RAT management operation comprises:
disabling support of inter-RAT related capability in NR Capability that is sent to the second PLMN.
